(19) United States
(12) Patent Application Publication
(10) Pub. No.: US 2021/0004737 A1
(43) Pub. Date: Jan. 7, 2021

(54) Journey Mapping

(71) Applicant: Well Fargo Bank, N.A., Charlotte, NC (US)

(72) Inventor: Michael Brians, Charlotte, NC (US)

(73) Assignee: WELLS FARGO BANK, N.A., Charlotte, NC (US)

(21) Appl. No.: 14/812,417

(22) Filed: Jul. 29, 2015

(51) Int. Cl. G06Q 10/06; G06Q 40/00

(52) U.S. Cl. CPC G06Q 10/0633; G06Q 40/00

(57) ABSTRACT

Systems, methods, and other embodiments associated with journey mapping are described herein. According to one embodiment, a method comprises adding a target persona to a canvas. An activity indicator is selected from a group of activity indicators to represent an activity of activities in a journey. The activity indicator is associated with a set of metrics. A metric in the set of metrics is associated with a set of values. The activity indicator is arranged relative to the target persona on the canvas. Values from the sets of values for metrics associated with the activity indicator.

### BACKGROUND

Business entities detail specific activities necessary to execute complex transactions. For example, a financial institution may detail a number of activities before a customer can receive a mortgage. While the detailed steps breakdown the process from the business entities' perspective, the business entity typically do not have defined way of analyzing the journey from the user's perspective. Better understating a user's perspective would give the business entity an opportunity to improve the user's experience. Furthermore, determining which activities the user has already completed or the step that the user is currently completing facilitates execution of the activities.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

Described herein are examples of systems, methods, and other embodiments associated with journey mapping. A journey is a series of activities to complete a transaction. A journey map visually illustrates a user's experience and the impact of each activity, based on facts about the user's expectations and the business entity's performance against these expectations. In one embodiment, the journey mapping may be associated with a financial institution. For example, financial professionals may create journey maps for a business entity in order to map each of the various activities a user, such as client, may undertake. The journey map maps the user's experiences throughout the process. In one embodiment, the journey map is developed based on facts supported by user feedback to improve the user's experience. For example, a financial professional may take steps to change the process in order to improve client experiences. Creating such maps may be time consuming because each step has to be individually formed.

To reduce the amount of time and processing power necessary to generate a journey map, embodiments described herein use predefined data graphics elements that provide an automated way to create journey-mapping symbology. For example, a box or other interconnected flow diagram element may be selected and dragged onto the canvas. Subsequently, all interconnected flow diagram elements can be selected as a whole or individually, and a pre-defined data graphics element can be applied. The user may then provide input to several metrics regarding client experience for the flow diagram element, and the data graphics element automatically formats the flow diagram element using appropriate journey mapping symbology. This allows the entity to create a journey map without having to manually create symbols, color-coding, font, etc. for each flow diagram element. Thus, the time and processing power to generate a journey map may be significantly reduced.

The following description and drawings set forth certain illustrative aspects and implementations. These are indicative of but a few of the various ways in which one or more aspects may be employed. Other aspects, advantages, or novel features of the disclosure will become apparent from the following detailed description when considered in conjunction with the drawings. While embodiments may be described with respect to customers and accounts of a financial institution, the systems, methods, and embodiments described herein may be used in other applications, such as for businesses, corporations, and non-profit organizations.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of a method associated with journey mapping.

FIG. 2A illustrates one example of a target persona screenshot associated with journey mapping.

FIG. 2B illustrates an example of an activity indicator screenshot associated with journey mapping.

FIG. 2C illustrates an example of a metric screenshot associated with journey mapping.

FIG. 3 illustrates one embodiment of a method including masking in journey mapping.

FIG. 4 illustrates another embodiment of a method associated with journey mapping.

FIG. 5A illustrates one embodiment of a system associated with journey mapping.

FIG. 5B illustrates one embodiment of a system attribute logic having associated with journey mapping.

FIG. 6A illustrates one example screen shot without a data graphics layer applied associated with journey mapping.

FIG. 6B illustrates one example screen shot with a data graphics layer applied associated with journey mapping.

FIG. 7 illustrates one embodiment of an example computer environment associated journey mapping.

### DETAILED DESCRIPTION

Embodiments or examples illustrated in the drawings are disclosed below using specific language. It will nevertheless be understood that the embodiments or examples are not intended to be limiting. Any alterations and modifications in the disclosed embodiments and any further applications of the principles disclosed in this document are contemplated as would normally occur to one of ordinary skill in the pertinent art. Described herein are examples of systems, methods, and other embodiments associated with journey mapping.

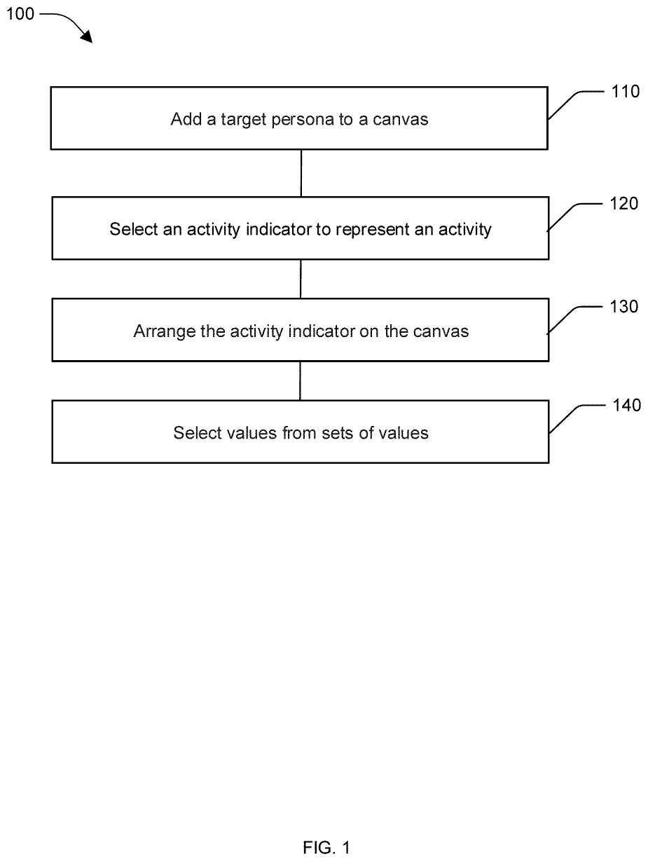

FIG. 1 is an illustration of an example embodiment of a method 100 for generating a journey map. The method 100 may be performed by an entity such as a corporation, non-profit group, financial institution, etc. that wishes to map a journey based on the experience of a user. The journey map may be generated using computer readable medium. For example, the steps described below may be executed in conjunction with electronic flowchart software.

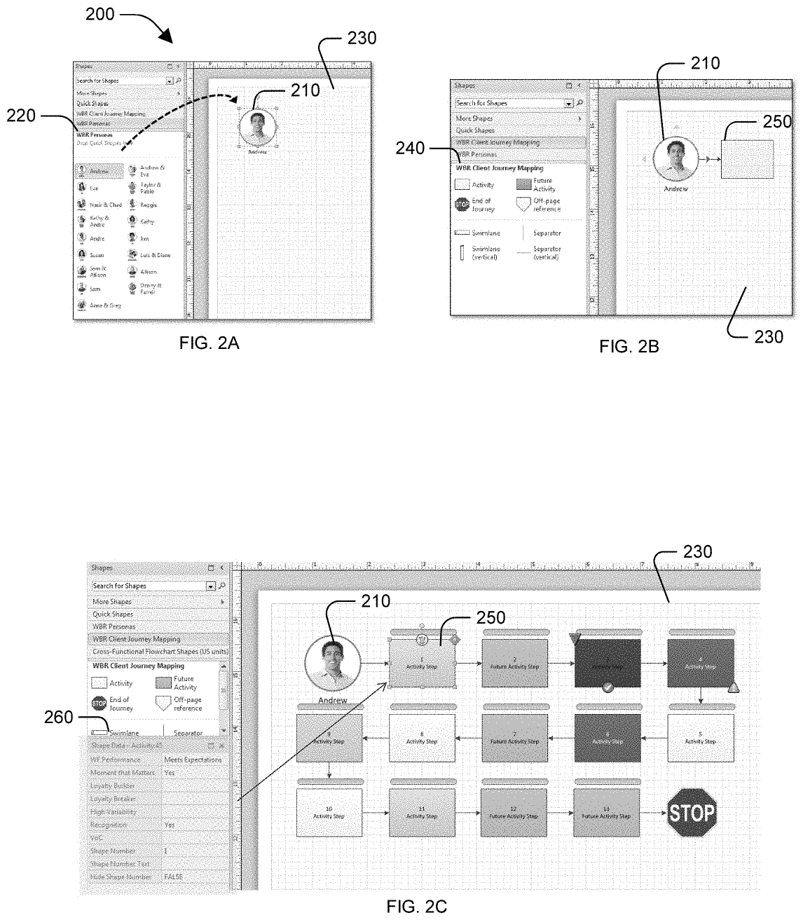

At 110, a target persona is added to a canvas. A target persona may be indicative of a user, such as a customer or applicant. In another embodiment, the target persona represents an organization doing business with the entity. Alternatively, the target persona may be an avatar that represents the experience of a fictitious user. A target persona may be selected from a group of personas that is prepopulated. Referring now to FIG. 2A, an example target persona screenshot associated with journey mapping is shown. A target persona 210 may be selected from a group of personas 220 and dragged to a canvas 230. The canvas 230 is an area where objects like the target persona can be pinned.

In one embodiment, the group of personas 220 is populated by the entity. For example, the group of personas may be a list of the entity's customers. As discussed above, the entity may use avatars as target personas. The entity may populate the group of personas 220 with avatars based on research, tests or scenarios that the entity wishes to analyze. For example, the entity may populate the group of personas 220 with avatars that represent a certain demographic or psychographic representation. The avatar may be generated to represent general experiences of a typical user or the imagined experience of a user.

Returning to method 100, at 120, an activity indicator is selected from a group of activity indicators. An activity indicator represents an activity step in the journey. Suppose that the target persona is an applicant applying for a loan from an entity. From the target persona's perspective, there are a number of activities to be performed, such as completing a loan application, initiating a home appraisal, etc. These activities are represented by activity indicators. Like the target personas, the activity indicators are prepopulated for ease of use. For example, the activity indicators available to be selected may be based on activities designed specifically for the journey. In another embodiment, the activity indicators are predetermined based on the types of services that the entity preforms.

Referring now to FIG. 2B that illustrates an example of an activity indicator screenshot associated with journey mapping. The target persona 210 and the canvas 230 operate in a similar manner as described above with respect to FIG. 2A. The activity indicator screenshot also includes a group of activity indicators 240 and an activity indicator 250. The indicator 250 is selected from the group of activity indicators 240 to represent an activity. In one embodiment, the activity indicator 250 is selected from the group of activity indicators 240 and dragged to the canvas 230. In another embodiment, the activity indicators most used can be identified as such within the group of activity indicators 240 allowing the addition of, for example, activity indicator 250 by hovering over any previously activity indicator that has been pinned to the canvas 230 and selecting it from options presented.

Different visual characteristics may be used for the activity indicators to differentiate between different types of activities. In one embodiment, the base-color of the activity indicator within the group of activity indicators 240 may identify the temporal nature of the activity. For example, white rectangles may identify current activities, while blue rectangles may identify future activities. In another embodiment, the shape of activity indicators may differentiate between different types of activities. While color and shape are described, the visual characteristic may also be a symbol, line thickness, etc.

Returning to FIG. 1, at 130, the activity indicator is arranged relative to the target persona on the canvas. For example, the activity indicator may be arranged relative to the target persona and other activities. In one embodiment, activity indicators are placed in sequential order relative to the target persona. In another embodiment, arranging the activity indicator includes applying predefined data graphics elements to the activity indicator. Referring now to FIG. 2C, which illustrates an example of a metric screenshot with the data graphics elements applied, associated with journey mapping. The target persona 210, the canvas 230, and the activity indicator 250 operate in a similar manner as described above with respect to FIGS. 2A and 2B. The metric screenshot of FIG. 2C also includes a set of metrics 260. When an activity indicator is selected, the set of metrics 260 and associated values are activated whether the data graphic elements are activated or not. In one embodiment where the data graphic elements are activated, the set of metrics being activated triggers the set of metrics 260 and corresponding values being displayed.

The metrics classify types of documented user feedback. For example, the set of metrics may include a performance metric, a material moment metric, a loyalty builder metric, a loyalty breaker metric, an experience variability metric, an emotion metric, a recognition metric, and an experience metric. A metric in the set of metrics is associated with a set of values that define the user's experience with respect to that metric. Returning to FIG. 1, at 140, values are selected from the pre-defined sets of values for metrics associated with the activity indicator. The selected value reflects the user's experience with respect to the activity associated with the activity indicator. Suppose that the activity indicator is associated with completing a loan application. The business entity's performance metric from the user's perspective may be associated with values, such as needs more data, exceeds expectations, meets expectations, and below expectations. An appropriate value for metrics can be selected based on user feedback captured through normal business entity determined feedback channels.

Accordingly, the graphics elements such as the target persona and activity indicators are predefined but can be tailored to a user's transactions using the set of metrics. By tailoring target personas and activity indicators, entities reduces the amount of time and processing power necessary to generate a journey map. Accordingly, the entity is able to create a journey map without having to manually create symbols, color-coding, font, etc. for each flow diagram element. Thus, the time and processing power to generate a journey map may be significantly reduced. While the examples described herein are in terms of customers and accounts, other indicia could also be used in accordance with the systems and methods described herein.

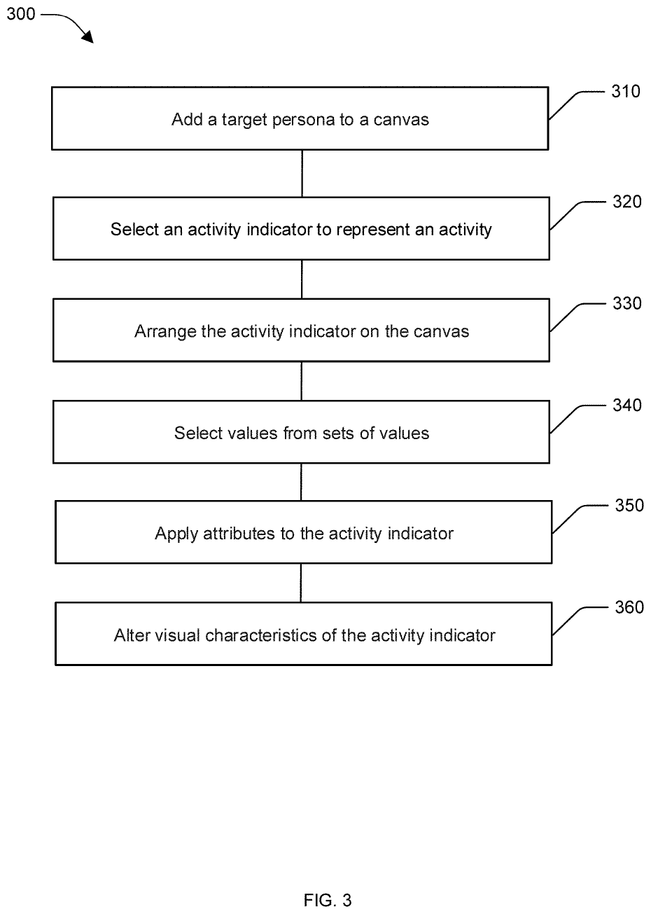

FIG. 3 illustrates another embodiment of a method associated with journey mapping. Steps 310, 320, 330, and 340 correspond to steps 110, 120, 130, and 140 of FIG. 1 and operate in a similar manner. Accordingly, at 310, a target persona is selected from a group of target personas and is added to a canvas. At 320, an activity indicator is selected from a group of activity indicators to represent and activity in journey. At 330, the activity indicator is arranged on the canvas relative to the target persona. As discussed above, an activity indicator is associated with a set of metrics by application of the data graphics element. In one embodiment, each metric is associated with at least one value. At 340, a value is selected for at least one metric of an activity indicator based on the user's experience. The user's experience is usually captured in a documented form.

At 350, attributes are applied to the activity indicator based, at least in part, on the selected values. The attributes may be determinations made based on a value or specific combinations of values. Suppose that a combination of values indicates that the user has had a disappointing experience. The combination of values may trigger application of an attribute to indicate a customer service follow-up during the activity corresponding to the activity indicator. Accordingly, the attributes may identify actions that can be taken based on the activities.

At 360, the visual characteristics of the activity indicator are altered based, at least in part, on the attributes. For example, a visual characteristic of the activity indicator may be altered to reflect that an attribute has been applied to the activity indicator. In another embodiment, a visual characteristic of the activity indicator may be altered to reflect a specific attribute such that activity indicators can be differentiated based on the visual characteristic being altered. As discussed above, the visual characteristic may be color, shape, a symbol, line thickness, etc.

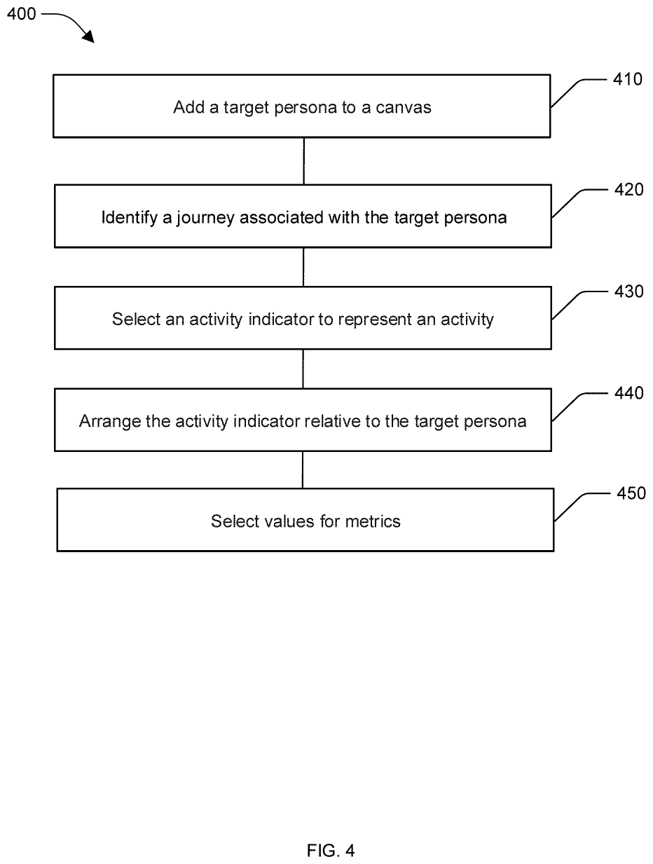

FIG. 4 illustrates one embodiment of a method including encoding in journey mapping. Steps 410, 430, 440, and 450 correspond to steps 110, 120, 130, and 140 of FIG. 1 and operate in a similar manner. As discussed above, at 410, a target persona is selected from a group of target personas and is added to a canvas. At 420, a journey associated with the target persona is identified. The journey includes a number of activities based on the transaction being completed. The journey may be predefined. In another embodiment, the activities of the journey are selected dynamically. The activities of the journey may be selected dynamically based on the values selected for previous activity indicators.

At 430, an activity indicator is selected from a group of activity indicators to represent an activity in the journey. At 440, the activity indicator is arranged on the canvas relative to the target persona. As discussed above, an activity indicator is associated with a set of metrics. In one embodiment, each metric is associated with at least one value. At 450, a value is selected for at least one metric of an activity indicator based on the user's experience.

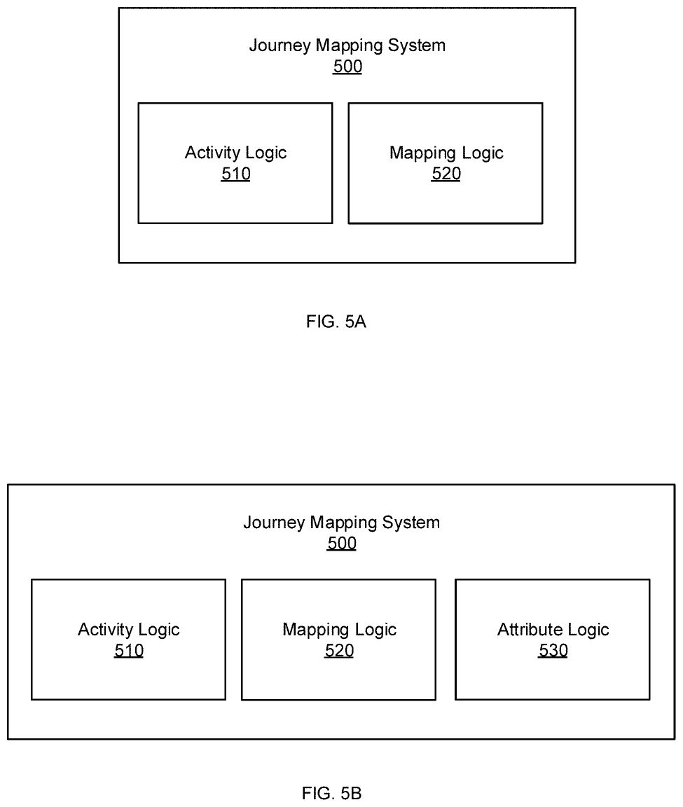

FIG. 5A illustrates one embodiment of a journey mapping system 500. The journey mapping system 500 includes an activity logic 510 and a mapping logic 520. The activity logic 510 defines a journey associated with a target persona. Activities are defined in a journey.

The mapping logic 520 receives a selection of an activity indicator from a group of activity indicators to represent an activity in the journey. As discussed above, the activity indicator is associated with a set of metrics. The activity indicator is arranged relative to the target persona on the canvas. The mapping logic 520 further receives a selection of values from the sets of values for metrics associated with the activity indicator.

FIG. 5B illustrates one embodiment of a journey mapping system 500. The activity logic 510 and mapping logic 520 operate in a similar manner as described with respect to FIG. 5A. The journey mapping system 500 further includes an attribute logic. The attribute logic 530 applies attributes to the activity indicator based, at least in part, on the selected values. As discussed above, an attributes may identify actions that can be taken with respect to the activities. The attribute logic 530 alters visual characteristics of the activity indicator on the canvas based, at least in part, on the attributes.

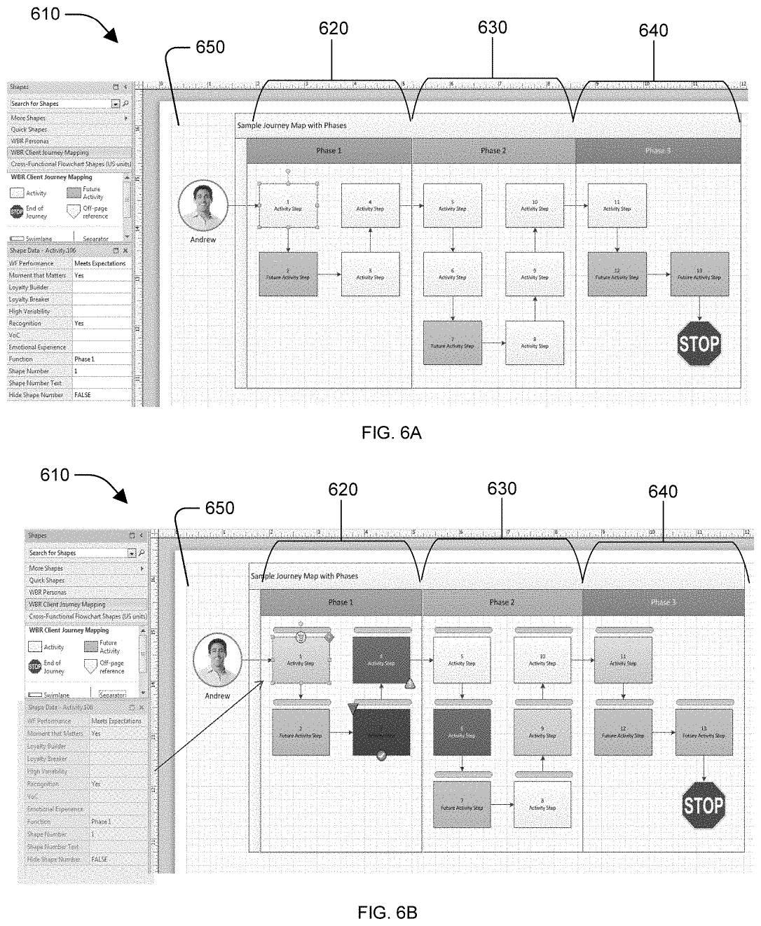

FIG. 6A illustrates one example screen shot without a data graphics layered applied associated with journey mapping. As discussed above, activity indicators are used to visually represent activities in a journey. A journey may be divided into phases. The phases are represented in a journey map 610. For example, the journey map 610 has three phases 620, 630, and 640 on the canvas 650. In one embodiment, phases are defined by delineating areas of the canvas 650. Activity indicators are arranged into the phases based on the phase associated with the activity.

FIG. 6B illustrates one example screen shot with a data graphics layered applied associated with the journey map 610. The journey map 610, the three phases 620, 630, and 640, and the canvas 650 operate in a similar manner as described above with respect to FIG. 6A. As discussed above, the phases represent stages in the journey. In one embodiment, the attributes of the activity indicators can be differentiated based on the visual characteristics of the activity indicator. The visual characteristics can be applied based on a data graphics layer. In one embodiment, an object, such as a URL or a file, can be associated with an activity indicator. For example, an object may be used to link documented Voice of the Customer data or reports to each activity indicator as a reference to substantiate the metrics assigned.

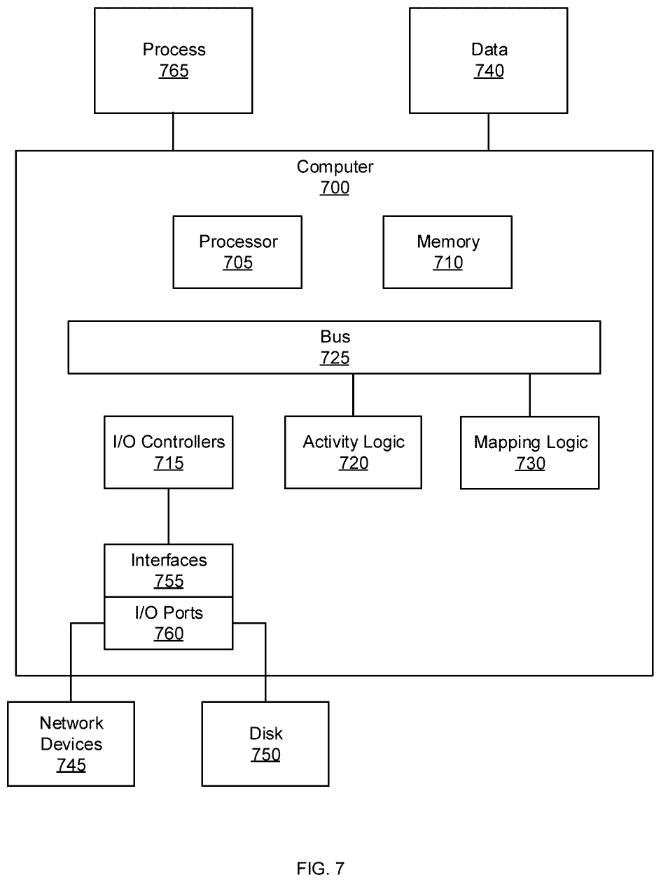

FIG. 7 illustrates one embodiment of an example computer environment associated entity mapping. The computer environment in which the systems and methods described herein, and equivalents, may operate may include a computer 700. The computer includes a processor 705, a memory 710, and input/output ports 760 operably connected by a bus 725. In one example, the computer 700 may include an activity logic 720 and a mapping logic 730. In different examples, the activity logic 720 and the mapping logic 730 may be implemented in hardware, a non-transitory computer-readable medium with stored instructions, firmware, and/or combinations thereof. While the activity logic 720 and the mapping logic 730 are illustrated as hardware components attached to the bus 725, it is to be appreciated that in one example, the activity logic 720 and/or the mapping logic 730 may be implemented in the processor 705.

In one embodiment, the activity logic 720 is a means (e.g., hardware, non-transitory computer-readable medium, firmware) for defining a journey associated with a target persona. The mapping logic 730 is a means (e.g., hardware, non-transitory computer-readable medium, firmware) is a means for receiving a selection of an activity indicator from a group of activity indicators to represent an activity in the journey. The mapping logic 730 is further a means for arranging the activity indicator relative to the target persona on the canvas. The mapping logic 730 is further a means for receiving a selection of values from the sets of values for metrics associated with the activity indicator. The means may be implemented, for example, as an ASIC programmed to trigger the tree logic to process transactions differently in each environment. The means may also be implemented as stored computer executable instructions that are presented to computer 700 as data 740 that are temporarily stored in memory 710 and then executed by processor 705.

Generally describing an example configuration of the computer 700, the processor 705 may be a variety of various processors including dual microprocessor and other multi-processor architectures. A memory 710 may include volatile memory and/or non-volatile memory. Non-volatile memory may include, for example, ROM, PROM, and so on. Volatile memory may include, for example, RAM, SRAM, DRAM, and so on.

A disk 750 may be operably connected to the computer 700 via, for example, an input/output interface (e.g., card, device) 755 and an input/output port 760. The disk 750 may be, for example, a magnetic disk drive, a solid state disk drive, a floppy disk drive, a tape drive, a Zip drive, a flash memory card, a memory stick, and so on. Furthermore, the disk 750 may be a CD-ROM drive, a CD-R drive, a CD-RW drive, a DVD ROM, and so on. The memory 710 can store a process 765 and/or a data 740, for example. The disk 750 and/or the memory 710 can store an operating system that controls and allocates resources of the computer 700.

The bus 725 may be a single internal bus interconnect architecture and/or other bus or mesh architectures. While a single bus is illustrated, it is to be appreciated that the computer 700 may communicate with various devices, logics, and peripherals using other busses (e.g., PCIE, 1394, USB, Ethernet). The bus 725 can be types including, for example, a memory bus, a memory controller, a peripheral bus, an external bus, a crossbar switch, and/or a local bus.

The computer 700 may interact with input/output devices via the i/o interfaces 755 and the input/output ports 760. Input/output devices may be, for example, a keyboard, a microphone, a pointing and selection device, cameras, video cards, displays, the network devices 745, the disk 750, and so on. The input/output ports 760 may include, for example, serial ports, parallel ports, and USB ports.

The computer 700 can operate in a network environment and thus may be connected to the network devices 745 via the I/O interfaces 755, and/or the I/O ports 760. Through the network devices 720, the computer 700 may interact with a network. Through the network, the computer 700 may be logically connected to remote computers. Networks with which the computer 700 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer storage medium”, as used herein, is a non-transitory medium that stores instructions and/or data. A computer storage medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer storage medium may include, but are not limited to, a computer-readable medium, a floppy disk, a flexible disk, a hard disk, a magnetic tape, other magnetic medium, an ASIC, a CD, other optical medium, a RAM, a ROM, a memory chip or card, a memory stick, and other media that can store instructions and/or data. Computer storage medium described herein are limited to statutory subject matter under 35 U.S.C § 101.

“Logic”, as used herein, includes a computer or electrical hardware component(s), firmware, a non-transitory computer storage medium that stores instructions, and/or combinations of these components configured to perform a function(s) or an action(s), and/or to cause a function or action from another logic, method, and/or system. Logic may include a microprocessor controlled by an algorithm to perform one or more of the disclosed functions/methods, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic component. Similarly, where a single logic component is described, it may be possible to distribute that single logic component between multiple physical logic components. In some embodiments, one or more of the components and functions described herein are implemented using one or more of the logic components. Logic as described herein is limited to statutory subject matter under 35 U.S.C § 101.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks. The methods described herein is limited to statutory subject matter under 35 U.S.C § 101.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. § 101.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A method, comprising:
executing, on a processor, instructions that cause the processor to perform acts comprising:
conveying, for display on a display device, a canvas for diagrammatic specification of a journey map capturing a user experience of a customer throughout a process, wherein the process comprises a series of activities to consummate a financial transaction;
receiving selection of a target persona, wherein the target persona represents the customer intending to complete the process;
conveying, for display on the display device, a graphical representation of the target persona on the canvas;
receiving documented user feedback;
converting the documented user feedback into a set of metrics;
receiving selection of an activity indicator to represent an activity of the series of activities in the process, wherein the activity indicator is associated with the set of metrics representative of the user experience of the customer, wherein each metric is associated with a set of values, and wherein the set of metrics include: a performance metric, a material moment metric, a loyalty builder metric, a loyalty breaker metric, an experience variability metric, an emotion metric, and a recognition metric in the set of metrics;
generating a graphical representation of the activity indicator including a graphic element representative of the set of metrics, wherein the graphic element is tailored according to the values associated with each metric in the set of metrics;
determining an arrangement of the activity indicator with respect to other activity indicators and target persona on the canvas based on a user experience metric, wherein the user experience metric measures the user's experience with graphical representations; and
conveying, for display on the display device, the arrangement on the canvas including the graphical representation of the activity indicator that is user specific tailored according to the set of metrics representative of the user experience of the customer.

2. (canceled)

3. The method of claim 1, further comprising organizing the activities into phases, and wherein the phases represent phases in the journey.

4. The method of claim 1, further comprising arranging a subset of activity indicators in a phase, wherein the subset of activity indicators share visual characteristics.

5. (canceled)

6. The method of claim 1, wherein the metrics include a Voice of Customer metric, and wherein a value associated with the Voice of Customer metric is undefined, and wherein an object links the Voice of the Customer data as a file to each activity indicator to be used as a reference to the Voice of Customer metric.

7. The method of claim 1, wherein a color of the activity indicator is based, at least in part, on a type of activity.

8. The method of claim 7, wherein a type of activity is one of a current activity type or a future activity type.

9. The method of claim 1, wherein the graphic element is determined by the set of values of at least one metric in the set of metrics, wherein the set of values affects one of a color of the activity indicator, a shape of the activity indicator, or a symbol on the activity indicator.

10. A system, comprising:
a processor coupled to a memory storing instructions that when executed by the processor cause the processor to:
define a journey associated with a target persona, wherein the journey includes activities to complete a process within the system and wherein the target persona is associated with a customer, wherein the target persona is an avatar selected from a group of avatars, each of the group of avatars representing different demographic or psychographic representations;
receive documented user feedback;
convert the documented user feedback into a set of metrics;
receive a selection of an activity indicator from a group of activity indicators to represent an activity of the activities, wherein the selection of the activity indicator is based on the set of metrics, and wherein a metric in the set of metrics is associated with a set of values, and wherein the metrics include at least an experience that captures user experience of a customer with respect to the activity, and wherein the metrics include: a performance metric, a material moment metric, a loyalty builder metric, a loyalty breaker metric, an experience variability metric, an emotion metric, and a recognition metric in the set of metrics;
arrange the activity indicator relative to the target persona on a canvas;
receive a selection of a values from the sets of values for a subset of metrics associated with the activity indicator;
apply attributes to the activity indicator based, at least in part, on the selected values;
alter visual characteristics of the activity indicator on the canvas based on the attributes such that the activity indicator is tailored according to the set of metrics representative of the user experience of the customer, wherein the set of metrics measures the user's experience with graphical representations; and
conveying, for display on a display device, the canvas including the target persona and the activity indicator that is user specific tailored according to the set of metrics representative of the user experience of the customer.

11. The system of claim 10, wherein the instructions further cause the processor to organize the activities into phases, and wherein the phases represent phases in the journey.

12. (canceled)

13. The system of claim 10, wherein the values associated with each of a performance metric, a material moment metric, a loyalty builder metric, a loyalty breaker metric, experience variability metric, recognition metric, an emotion metric, and an experience metric are predefined.

14. The system of claim 10, wherein a target persona is based at least in part on a customer of a financial entity.

15. A non-transitory computer-readable medium storing computer-executable instructions that when executed by a computer cause the computer to perform a method, the method comprising:
conveying, for display on a display device, a canvas for diagrammatic authoring of a journey map capturing a user experience of a customer throughout a process, wherein the process comprises a series of activities to consummate a financial transaction;
receiving selection of a target persona that represents the customer intending to complete the process;
generating an updated canvas including a graphical representation of the target persona;
conveying, for display on the display on the display device, the updated canvas replacing the canvas;
receiving documented user feedback;
converting the documented user feedback into a set of metrics;
receiving selection of an activity indicator associated with the target persona, wherein the activity indicator represents an activity of the series of activities in the process, wherein the activity indicator is based on the set of metrics, and wherein the set of metrics is associated with a set of values, and wherein the set of metrics include an experience metric capturing the user experience of the customer associated with the activity, and wherein the set of metrics include: a performance metric, a material moment metric, a loyalty builder metric, a loyalty breaker metric, an experience variability metric, an emotion metric, and a recognition metric in the set of metrics;
generating a graphical representation of the activity indicator including a graphic element representative of the set of metrics, wherein graphic element is user specific tailored according to the values associated with each metric in the set of metrics;
determining an arrangement of the activity indicator with respect to other activity indicators based on a user experience metric, wherein the user experience metric measures the user's experience with graphical representations; and
generating a second updated canvas including the graphical representation of the activity indicator that is tailored according to the set of metrics representative of the user experience of the customer in the arrangement;
conveying, for display on the display device, the updated canvas;
receiving updated set of metrics for the activity indicator;
generating a third updated canvas including a changed graphic element representative of the updated set of metrics; and
conveying, for display on the display device, the third updated canvas replacing the second updated canvas.

16. (canceled)

17. The non-transitory computer-readable medium of claim 15, wherein the values associated with each of a performance metric, a material moment metric, a loyalty builder metric, a loyalty breaker metric, experience variability metric, an emotion metric, recognition metric, and an experience metric are predefined.

18. The non-transitory computer-readable medium of claim 15, wherein a subset of activity indicators arranged in a phase share a visual characteristics.

19. The non-transitory computer-readable medium of claim 18, wherein the visual characteristic is determined by the set of values of at least one metric in the set of metrics, wherein the set of values affects one of a color of the activity indicator, a shape of the activity indicator, or a symbol on the activity indicator.

20. The non-transitory computer-readable medium of claim 15, wherein a target persona is based at least in part on a customer of a financial entity.

21. The method of claim 1, further comprising:
receiving a change to a value of a metric of the set of metrics associated with the activity indicator;
generating an updated canvas including a change in a visual characteristic of the activity indicator based on the change in the metric; and
conveying, for display on the display device, the updated canvas.

22. The system of claim 10, wherein the visual characteristic is determined by the set of values of at least one metric in the set of metrics, wherein the set of values affects one of a color of the activity indicator, a shape of the activity indicator, or a symbol on the activity indicator.
